(19) United States
(12) Patent Application Publication
(10) Pub. No.: US 2011/0109451 A1
(43) Pub. Date: May 12, 2011

(54) Cheatham's seat belts usage indicator

(76) Inventor: Vincent Cheatham, Philadelphia, PA (US)

(21) Appl. No.: 12/925,907

(22) Filed: Nov. 2, 2010

Related U.S. Application Data
(60) Provisional application No. 61/280,312, filed on Nov. 2, 2009.

(51) Int. Cl. B60Q 1/26

(52) U.S. Cl. 340/468

(57) ABSTRACT

The present invention provides the Cheatham Seat Belt Usage Indicator comprising a vehicular lighting system that provides a visual indication to law enforcement whether or not a motorist is driving with the seat belt fastened. This invention comprises a series of lights, and the appropriate wire assemblies for connecting these beacons to an automobile's seat belt apparatuses, incorporated into the seat belts themselves. The seat belts are emblazoned with the name “Cheatham” running along the length of the belt.

### CLAIM OF PRIORITY

This patent application claims priority under 35 USC 119 (e) (1) from U.S. Provisional Patent Application Ser. No. 61/280,312 filed Nov. 2, 2009, of common inventorship herewith entitled, “Cheatham's Seat Belts Usage Indicator.”

### FIELD OF THE INVENTION

The present invention pertains to the field of seat belt usage compliance, and more specifically to the field of external warning systems alerting occupant compliance, such as the visual display of lights.

### BACKGROUND OF THE INVENTION

The prior art has put forth several designs for devices providing visual warnings for seat belt usage compliance. Among these are:

U.S. Pat. No. 4,849,733 to Conigliaro describes an electrical system providing audible or visible displays indicating seat belt usage.

U.S. Pat. No. 6,059,066 to Lary describes a method indicating seat belt usage to observers outside the vehicle.

U.S. Pat. No. 7,283,043 to Harrison describes a safety system designed to visibly indicate usage of seatbelts within a vehicle.

US Patent 20038/0160689 to Yazdgerdi describes an apparatus designed to provide visible warning when a vehicle's occupant remains unbuckled in a car seat.

None of these prior art references describe the present invention.

### SUMMARY OF THE INVENTION

It is an object of the present invention to provide a visual means for law enforcement to determine seat belt usage as well as safety reminders for the occupants when seat belts are not used.

### BRIEF DESCRIPTION OF THE DRAWINGS

FIG. 1 is a front perspective view of an automobile utilizing the device of the present invention.

FIG. 2 is a close up view of the lighting system configuration of the device of the present invention on the side of an automobile.

FIG. 3 is a close up view of the lighting system configuration of the device of the present invention on the front of an automobile.

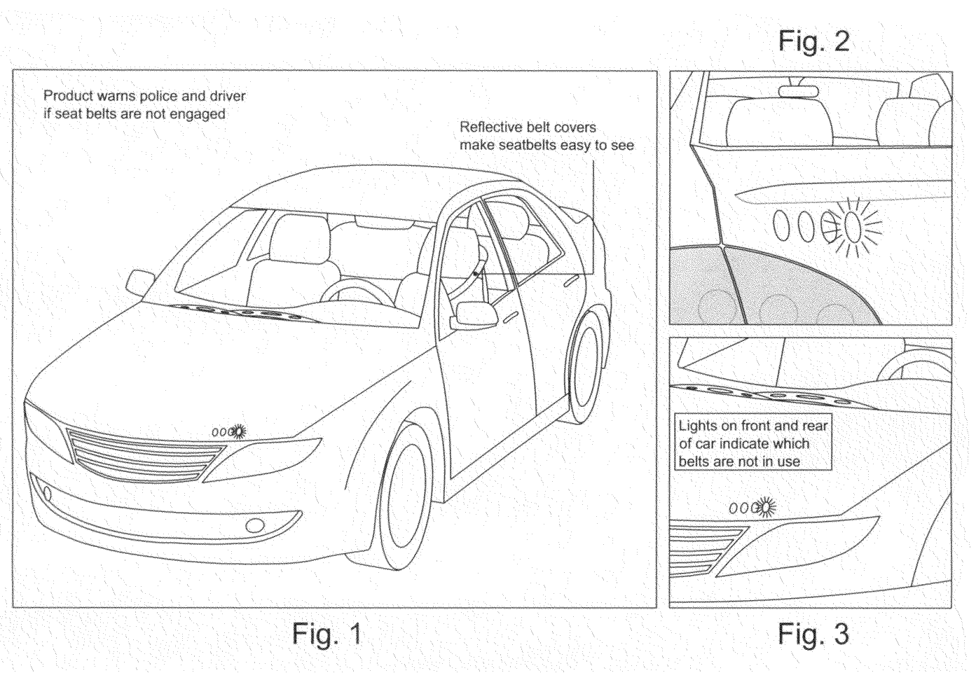

### DETAILED DESCRIPTION OF THE INVENTION

In every state there are laws that require every resident to wear a seat belt while in a moving vehicle. Long proven to save lives and protect from injury, seatbelts are the most effective safety device in motor vehicles, preventing over 11,000 deaths each year. However, 27 percent of motorists still don't use their seatbelts). All states have seat belt requirements, and the majority of them (31), have enacted laws that permit police to issue tickets for failure to use seat belts only if the car is stopped for another violation. This may seem like a minor distinction, but studies have found that by giving police authority to issue tickets for failing to wear a seat belt, whether or not there is another violation, makes a big difference in the number of motorists who wear them. Police officers face a daunting challenge trying to enforce seat belt laws.

Recognizing the need for a device that encourages motorists to increase their seat belt usage, the present invention was developed and is hereinafter referred to as the Cheatham Seat Belt Usage Indicator Usage Indicator. Simply stated, the Cheatham Seat Belt Usage Indicator is a vehicular lighting system that provides a visual indication to law enforcement whether or not a motorist is driving with the seat belt fastened. This invention comprises a series of lights, and the appropriate wire assemblies for connecting these beacons to an automobile's seat belt apparatuses, incorporated into the seat belts themselves. The seat belts are emblazoned with the name “Cheatham” running along the length of the belt. Offered in colors red or green, the light bulbs are 20-watt, incandescent single filament quartz bulbs, the type commonly used for vehicle brake lights. Once the Cheatham Seat Belt Usage Indicator system has been installed in an automobile, the lights are directly connected to the seat belts, activating or deactivating based on whether the seat belts are used. When all persons in the car are buckled up, the lights are green. If the driver or another passenger neglects to fasten their seat belt, the red lights shine and alert passing police to this traffic violation. Thus informed, law enforcement officers stop the vehicle and issue a ticket, or closely monitor the car in states with limited ticketing authority. Also the red lights effectively remind the passenger or motorist to buckle up before they receive a ticket.

There are several significant benefits and advantages associated with this unique invention. Foremost, the Cheatham Seat Belt Usage Indicator provides encouragement to utilize a seat belt every time one enters a motor vehicle. Offered both with the original manufacture of a vehicle as well as to the vehicle aftermarket, this handy device improves seat belt usage across the country, saving thousands of lives and preventing even more injuries. Configured to shine green when belts are fastened, and to shine bright red when belts are not worn, the Cheatham Seat Belt Usage Indicator lights serve as illuminated reminders for motorists to buckle up.

In addition, law enforcement certainly appreciate the visual indications offered by this system, as these clear-cut signals of seat belt usage or the lack thereof allow them to do their jobs in an easier, more certain manner. Properly installed, the Cheatham Seat Belt Usage Indicator afford drivers years of continued use.

The Cheatham Seat Belt Usage Indicator system is an innovative product invention that readily improves the safety of highways. Inspiring confidence and peace of mind in conscientious drivers while encouraging others to practice safer driving, this invention benefits all who take to the roads. Affordably priced, the Cheatham Seat Belt Usage Indicator will be well received by motorists, automobile manufacturers, and law enforcement.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. Visual seat belt usage indicator and awareness device, comprising: a vehicular lighting system comprising a visual indication of seatbelt usage wherein a green light illuminates when the seatbelts of all persons in a vehicle are engaged, and wherein a red light illuminates if the seatbelts of all persons in a vehicle are not engaged.

2. The device of claim 1 wherein the lights are mounted on the outside of a vehicle.

3. The device of claim 1 wherein the lights are mounted on the front and the rear of the outside of the vehicle.

4. The device of claim 1 further comprising the name “Cheatham” embroidered, painted, woven or otherwise mounted or affixed to the length of the seat belt.
